(19) United States
(12) Patent Application Publication
(10) Pub. No.: US 2025/0088904 A1
(43) Pub. Date: Mar. 13, 2025

(54) Bluetooth Loading and Thread Packet Size

(71) Applicant: Apple Inc., Cupertino, CA (US)

(72) Inventors: Yaranama Venkata Ramana DASS, Belmont, CA (US); Arun Vijayakumari MAHASENAN, Fremont, CA (US); David D CHENG, Los Altos, CA (US); Hsin-Yao CHEN, Castro Valley, CA (US); Langford M WASADA, Poway, CA (US); Paul V FLYNN, Menlo Park, CA (US); Venkateswara Rao MANEPALLI, San Jose, CA (US)

(21) Appl. No.: 18/826,970

(22) Filed: Sep. 6, 2024

Related U.S. Application Data
(60) Provisional application No. 63/581,344, filed on Sep. 8, 2023.

(51) Int. Cl. H04W 28/06; H04W 28/08; H04W 76/15

(52) U.S. Cl. CPC H04W 28/06; H04W 28/08; H04W 76/15

(57) ABSTRACT

An apparatus configured to establish a first radio link for short range communications using a first protocol and a second radio link for short range communications using a second protocol, wherein the first and second radio links share an antenna, process traffic load information for the first radio link, the information being dependent on configuration parameters for the first radio link, determine, based on the information, time domain resources available for second data traffic on the second radio link, based on the time domain resources available for the second data traffic on the second radio link, determine a fragmentation size for packets sent on the second radio link and generate transmissions to exchange the second data traffic in the time domain resources available for the second data traffic on the second radio link in fragmented packets according to the determined fragmentation size.

### PRIORITY/INCORPORATION BY REFERENCE

This application claims priority to U.S. Provisional Application Ser. No. 63/581,344 filed on Sep. 8, 2023, entitled “Bluetooth Loading and Thread Packet Size,” the entirety of which is incorporated by reference herein.

### BACKGROUND

A user equipment (UE) may comprise a radio and an antennas or antenna arrays for short-range connections to another device, e.g., Wi-Fi Direct, Bluetooth, Bluetooth Low Energy (BLE), etc. In recent years, the Thread protocol was developed for short-range mesh network applications including, e.g., Internet of things (IoT) applications such as smart homes. The antenna or antenna array used for Wi-Fi, BLE, etc. may also be used for Thread communications. If the UE is simultaneously configured for multiple radio links using different short-range protocols, e.g., BLE and Thread, the UE cannot transmit (Tx) and/or receive (Rx) simultaneously on both radio links. There is a need for mechanisms to ensure coexistence between the multiple radio links.

### SUMMARY

Some example embodiments are related to an apparatus having processing circuitry configured to establish a first radio link for short range communications using a first protocol and a second radio link for short range communications using a second protocol, wherein the first and second radio links share an antenna, process traffic load information for the first radio link, the information being dependent on configuration parameters for the first radio link, determine, based on the information, time domain resources available for second data traffic on the second radio link, based on the time domain resources available for the second data traffic on the second radio link, determine a fragmentation size for packets sent on the second radio link and generate transmissions to exchange the second data traffic in the time domain resources available for the second data traffic on the second radio link in fragmented packets according to the determined fragmentation size.

Other example embodiments are related to an apparatus having processing circuitry configured to establish a radio link for short range communications using a wireless protocol, process data traffic on the radio link from a source device, the data traffic transmitted by the source device in a transmission pattern with a fragmentation size, detect the fragmentation size and the transmission pattern and generate, for transmission on the radio link to the source device, transmissions in accordance with the detected fragmentation size and the transmission pattern.

Still further example embodiments are related to a method for establishing a first radio link for short range communications using a first protocol and a second radio link for short range communications using a second protocol, wherein the first and second radio links share an antenna, processing traffic load information for the first radio link, the information being dependent on configuration parameters for the first radio link, determining, based on the information, time domain resources available for second data traffic on the second radio link, based on the time domain resources available for the second data traffic on the second radio link, determining a fragmentation size for packets sent on the second radio link and generating transmissions to exchange the second data traffic in the time domain resources available for the second data traffic on the second radio link in fragmented packets according to the determined fragmentation size.

### BRIEF DESCRIPTION OF THE DRAWINGS

FIG. 1 shows an example arrangement according to various example embodiments.

FIG. 2 shows an example user equipment (UE) according to various example embodiments.

FIG. 3a shows a slot diagram including example patterns for traffic over a first type of radio link for a first short range protocol and available resources for traffic over a simultaneously configured radio link for a second short range protocol according to a first example.

FIG. 3b shows a slot diagram including example patterns for traffic over a second type of radio link for a first short range protocol and available resources for traffic over a simultaneously configured radio link for a second short range protocol according to a second example.

FIG. 3c shows a slot diagram including example patterns for traffic over a third type of radio link for a first short range protocol and available resources for traffic over a simultaneously configured radio link for a second short range protocol according to a third example.

FIG. 3d shows a slot diagram including example patterns for traffic over a fourth type of radio link for a first short range protocol and available resources for traffic over a simultaneously configured radio link for a second short range protocol according to a fourth example.

FIG. 3e shows a slot diagram including example patterns for traffic over a fifth type of radio link for a first short range protocol and available resources for traffic over a simultaneously configured radio link for a second short range protocol according to a fifth example.

FIG. 3f shows a slot diagram including example patterns for traffic over a sixth type of radio link for a first short range protocol and available resources for traffic over a simultaneously configured radio link for a second short range protocol according to a sixth example.

FIG. 4 shows a method for coexistence between a first short-range communications protocol and a second short-range communications protocol when radio links for these protocols are simultaneously configured and these links share an antenna according to various example embodiments.

### DETAILED DESCRIPTION

The example embodiments may be further understood with reference to the following description and the related appended drawings, wherein like elements are provided with the same reference numerals. The example embodiments relate to operations for coexistence between two short-range radio links sharing a single antenna or antenna array.

The example embodiments are described with regard to a user equipment (UE). However, reference to a UE is merely provided for illustrative purposes. The example embodiments may be utilized with any electronic component that is equipped with the hardware, software, and/or firmware to wirelessly exchange signals with a network and/or another remote device. Therefore, the UE as described herein is used to represent any electronic component.

The example embodiments are also described with regard to a UE enabled for multiple radio links using different short-range protocols. Bluetooth (e.g., Bluetooth, Bluetooth Low-Energy (BLE), etc.) is a specific type of communication protocol that enables short-range communication between two or more devices. Many different types of radio links may be established using the Bluetooth protocol, including, e.g., a synchronous connection-oriented (SCO) link, an enhanced SCO (eSCO) link, and various types of Bluetooth audio links for applications such as hearing aids. The Thread protocol refers to a short-range protocol for mesh network applications including, e.g., Internet of things (IoT) applications such as smart homes.

While the example embodiments are described with regard to coexistence between Bluetooth and Thread, the example embodiments are not limited to these wireless communication protocols and may be implemented using any appropriate type of wireless communication protocol. Therefore, any reference to terms such as, “Bluetooth,” “BLE,” “Thread,” “short-range communication protocol,” “short-range connection,” or “short-range communication link” are provided for illustrative purposes and not intended to limit the example embodiments to any particular type of wireless communication protocol.

A user equipment (UE) may comprise a number of antennas or antenna arrays, e.g., at least two, wherein one of the antennas or antenna arrays is for connecting to a cellular network, e.g., a 5G New Radio (NR) radio access network (RAN), and another one of the antennas or antenna arrays is for short-range connections to another device, e.g., Wi-Fi, Bluetooth, Bluetooth Lowe Energy (BLE), Thread, etc. The antenna or antenna array used for Wi-Fi, BLE, etc. may also be used for Thread communications. If the UE is simultaneously configured for multiple radio links using different short-range protocols, e.g., BLE and Thread, the UE cannot transmit (Tx) and/or receive (Rx) simultaneously on both radio links. Accordingly, mechanisms should be developed to enable coexistence between the multiple short-range protocols.

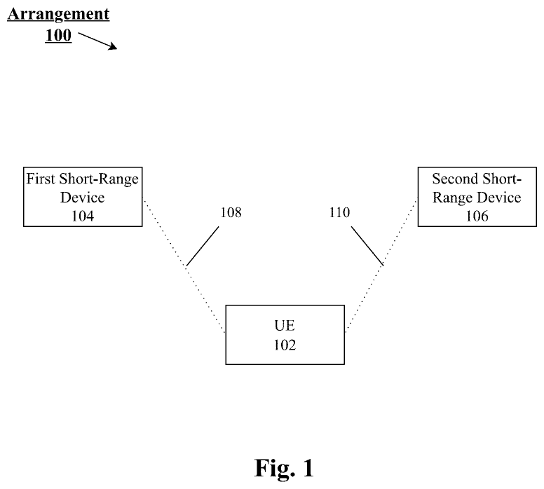

FIG. 1 shows an example arrangement 100 according to various example embodiments. The arrangement 100 includes a UE 102, a first short-range device 104 and a second short-range device 106. The UE 102 may be any type of electronic component that is configured to communicate via a short-range wireless connection, e.g., mobile phone, tablet computer, desktop computer, smartphone, embedded device, wearable (e.g., HMD, AR glasses, etc.), Internet of Things (IoT) device, etc. To provide a non-limiting example within the context of the example arrangement 100, the UE 102 may be a mobile phone.

The UE 102 may communicate with the first short-range device 104 and the second short-range device 106 using respective short-range communication protocols. In one example, the first short-range device 104 may be an electronic device enabled for Bluetooth communications such as, e.g., a wearable device, and the second short-range device 106 may be an electronic device enabled for Thread communications such as, e.g., an access point or router that is a node in a local area network (LAN) or wireless LAN (WLAN) in a Thread mesh network architecture, e.g., for a smart home. The UE 102 and the first short-range device 104 are configured with parameters necessary to establish a first short-range radio link 108. In one example, the first link 108 comprises a Bluetooth radio link which can be, e.g., an SCO link, an eSCO link, or another type of Bluetooth radio link. The UE 102 and the second short-range device 106 are configured with parameters necessary to establish a second short-range radio link 110. In one example, the second link 110 comprises a Thread radio link. In the present example embodiments, the first and second links 108, 110 comprise different types of radio links for different wireless protocols, e.g., Bluetooth and Thread.

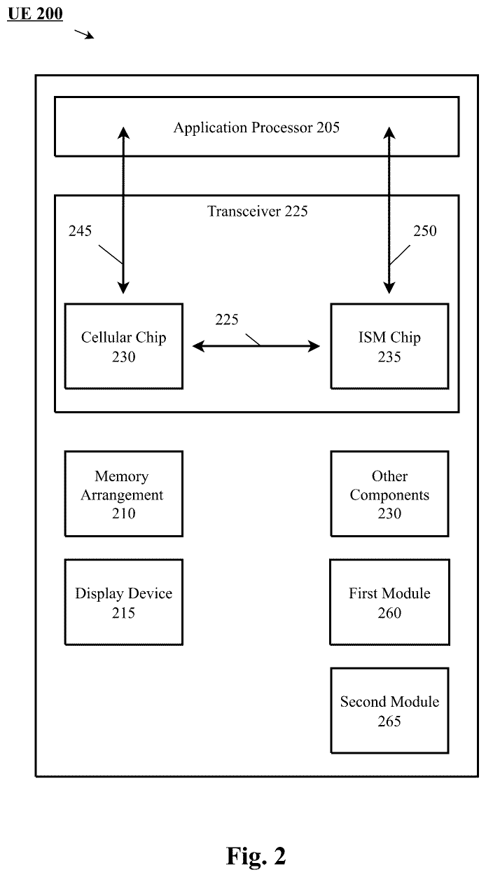

FIG. 2 shows an example UE 200 according to various example embodiments. The UE 200 may represent the UE 102 from the arrangement 100 of FIG. 1 or any other type of device configured to communicate directly with another device using a short-range communication protocol. The UE 200 may include an application processor 205, a transceiver 225, a cellular chip 230, an industrial scientific and medical (ISM) chip 235, a memory arrangement 210, a display device 215, a first short-range communications module 260 for a first short-range protocol, a second short-range communications module 265 for a second short-range protocol, and other components 220. The other components 220 may include, for example, an input/output (I/O) device, an audio input device, an audio output device, a power supply, a data acquisition device, ports to electrically connect the UE 200 to other electronic devices, sensors to collect data from a user, etc.

The application processor 205 may be configured to execute a plurality of applications for the UE 200. For example, the applications may include, but are not limited to, a web browser, a health monitoring application, a voice call application and a smart home application.

The memory arrangement 210 may be a hardware component configured to store data related to operations performed by the UE 200. The display device 215 may be a hardware component configured to show data to a user. The display device 215 and an I/O device may be separate components or integrated together such as a touchscreen.

The transceiver 225 may be a hardware component configured to wirelessly transmit and/or receive data. Thus, the transceiver 225 may enable communication with other electronic devices directly or indirectly through a network. The transceiver 225 may operate on a variety of different frequencies or channels (e.g., set of consecutive frequencies) that are related to a cellular network and/or a WLAN network. The transceiver 225 may also perform wireless functionalities for short range communications such as Bluetooth, BLE, Thread, etc. Accordingly, the transceiver 225 may work in conjunction with a cellular chip 230 for the wireless functionalities related to cellular networks and an ISM chip 235 for the wireless functionalities for short-range communications such as Bluetooth, BLE, etc.

The components of the UE 200 may be disposed at least partially on an integrated circuit board (ICB). Accordingly, the cellular chip 230, the ISM chip 235, and the application processor 205 may be disposed on the ICB in which pathways may also exist between these components. For example, an interface 245 may be disposed to connect the cellular chip 230 to the applications processor 205 while interface 250 may be disposed to connect the ISM chip 235 to the applications processor 205. In addition, a coexistence interface 255 may be disposed to connect the cellular chip 230 to the ISM chip 235. The manner in which the cellular chip 230, the ISM chip 235, and the application processor 205 may be disposed on the ICB as well as the manner in which the interfaces or pathways 245, 250, 255 may be provided for the interconnections are only examples of an arrangement of an ICB. The example embodiments may be implemented in any of these or other configurations of a UE.

In addition, the UE 200 may include the first and second short range communications module 260, 265. The first short range communications module 260 may enable short-range communications using a first protocol, e.g., Bluetooth, and the second short range communications module 265 may enable short-range communications using a second protocol, e.g., Thread. The first module 260 may perform various operations related to transmitting and receiving data/signals, e.g., packets, over the first short-range radio link 108. The second module 265 may perform various operations related to transmitting and receiving data/signals, e.g., packets, over the second short-range radio link 110. The first and second module 260, 265 may exchange information, e.g., information related to the traffic load on their respective radio links, either directly or via one or more other modules, e.g., a wireless radio manager.

The first and second short-range communications modules 260, 265 may be implemented as firmware or as separate incorporated components of the UE 200, may be a modular component coupled to the UE 200, e.g., an integrated circuit. For example, the integrated circuit may include input circuitry to receive signals and processing circuitry to process the signals and other information. In some embodiments, the operations performed by the modules 260, 265 may instead be performed by an integrated circuit without firmware, a baseband processor, the application processor 205, any combination thereof or any other appropriate component.

Returning to FIG. 1, the UE 102 and the first short-range device 104 may communicate using a first short-range communication protocol (e.g., Bluetooth, BLE, etc.). Accordingly, when the UE 102 and the first device 104 are within a proximity of one another (e.g., within a distance in which BLE communications may be performed), the UE 102 and the first device 104 may exchange data over the first radio link 108. The UE 102 and the first device 104 may have a companion relationship where the UE 102 is a source device and the first device 104 is an accessory device. Thus, in some examples, the UE 102 may connect to a network and relay data exchanged with the network to the first device 104 over the short-range communication link 120.

The UE 102 and the second short-range device 106 may communicate using a second short-range communication protocol (e.g., Thread). Accordingly, when the UE 102 and the second device 106 are within a proximity of one another (e.g., within a distance in which Thread communications may be performed), the UE 102 and the second device 106 may exchange data over the second radio link 110. The UE 102 and the second device 106 may have a relationship where the UE 102 is a source device for, e.g., issuing commands to be executed at one or more nodes of a mesh network, and the second device 106 is an access point or router device capable of communications with both the UE 102 and with further nodes of the mesh network such that communications received from the UE 102 can be forwarded to an appropriate node or nodes in the mesh network and communications received from the node(s) can be forwarded to the UE 102.

Short-range communication protocols enabling the establishment of the first and second links 108, 110 may have certain similarities. For example, these communication protocols may operate in the same frequency ranges, may use similar Tx/Rx techniques, etc. The UE 102 may use the same antenna for both the first and second radio links 108, 110.

In some scenarios, the first and second radio links 108, 110 are configured simultaneously. When the same antenna is used for Tx/Rx on both radio links, the first and second protocols enabling the links 108, 110 should ensure coexistence such that the radio resources (particularly in the time domain) are appropriately shared. In some cases, one of the radio links may have higher priority data than the other radio link. In an example scenario, the quality of both radio links 108, 110 will meet minimum requirements so that the user experience is acceptable for both applications.

According to various example embodiments described herein, traffic load-related information for transmissions and/or receptions on a first radio link for a first short range protocol or radio access technology (RAT) can be provided to a module of a second short range protocol or RAT so that transmissions and/or receptions on a second radio link for the second short range protocol can be scheduled and/or performed in dependence on the traffic load-related information for the first radio link. In the present example embodiments, the first and second links share a single antenna or antenna array such that coexistence should be ensured between the links and the radio resources available for the first and second radio links, particularly in the time domain, can be shared. In some examples, the first short range protocol is Bluetooth and the first radio link is a Bluetooth or BLE link, e.g., SCO, eSCO, or audio for a particular application, e.g., hearing aids. In some examples, the second short-range protocol is Thread and the second radio link is a Thread link. However, the principles described herein can be applied for different combinations of links.

Returning to the example introduced above with regard to FIG. 1, the first device 104 can be a Bluetooth-enabled device such as a wearable device that transmits data to and receives data from the UE 102 as a source device that is connected to a wider network such as, e.g., the 5G NR RAN. In one example, the first device 104 can enable voice communications via the first radio link 108, e.g., a voice call executed by the UE 102. The second device 106 can be a Thread-enabled device such as an access point or router that can relay information or commands to/from the UE 102. In one example, the UE 102 can execute a smart home application and transmit a command, e.g., to lock or unlock a door. The second device 106 can relay the command to an appropriate node in the mesh network of the smart home so that, ultimately, the command is executed and the door is locked/unlocked. In another example, a sensor in the smart home system can transmit information and/or an alert upstream so that the message is received by the second device 106 (e.g., router) and forwarded to the UE 102.

When two short range radio links are configured for a UE, and these radio links share an antenna, the UE cannot transmit/receive on both radio links at the same time. Thus, in a scenario where data is pending on both links, one of the links can be prioritized such that the data is sent on the prioritized link and the data on the non-prioritized link waits to be transmitted until radio resources are available (e.g., not used by the UE on the prioritized link). In the example scenario described above, the first radio link 108 enabling the voice call may be considered to have a higher priority than the second radio link 110 enabling the UE 102 to interface with the smart home network. For example, it may be desirable to ensure that there are no audio gaps or loss of the audio connection on the first radio link 108, whereas, on the second radio link 110, a smart home command may be less time-sensitive.

In other scenarios, communications over the second radio link 110 may have a higher priority. In other scenarios, neither radio link may have a clear priority over the other. Certain communications applications may involve transmissions/receptions over one of the radio links of a minimum quality. For example, some radio links may enable one or more retransmissions for data packets, where a higher number of retransmissions may ensure a higher quality of the radio link but a lower number or no retransmissions may ensure an adequate quality of the radio link.

According to some example embodiments, a first short-range radio link for a UE may be prioritized over a second short-range radio link for the UE such that communications are performed over the first link without regard to the second link and communications are performed over the second link on available time domain resources, e.g., those time domain resources that are not used for the communications over the first link. In one example, the first link is a Bluetooth link and the second link is a Thread link. The Bluetooth link may comprise, e.g., an SCO link, an eSCO link, or one of multiple types of audio link. In these embodiments, the Bluetooth link can comprise a periodic transmission and reception scheme that may or may not include retransmissions. Depending on the traffic load of the Bluetooth link, the Thread link may be used at times when the Bluetooth link is not being used. In some embodiments to be described further below, if the contiguous available time domain resources are not sufficient to support a minimum packet size over the Thread link, then no transmissions or receptions will be made on the Thread link until the load on the Bluetooth link changes.

As described above, the UE can comprise a respective module for facilitating the first short-range link (e.g., Bluetooth link) and for facilitating the second short-range link (e.g., Thread link). In these embodiments, a second module (e.g., Thread module) can receive traffic load information for the first link directly or indirectly from a first module (e.g., Bluetooth module). Based on the traffic load information, the second module can determine where in the time domain a packet can be transmitted on the second link.

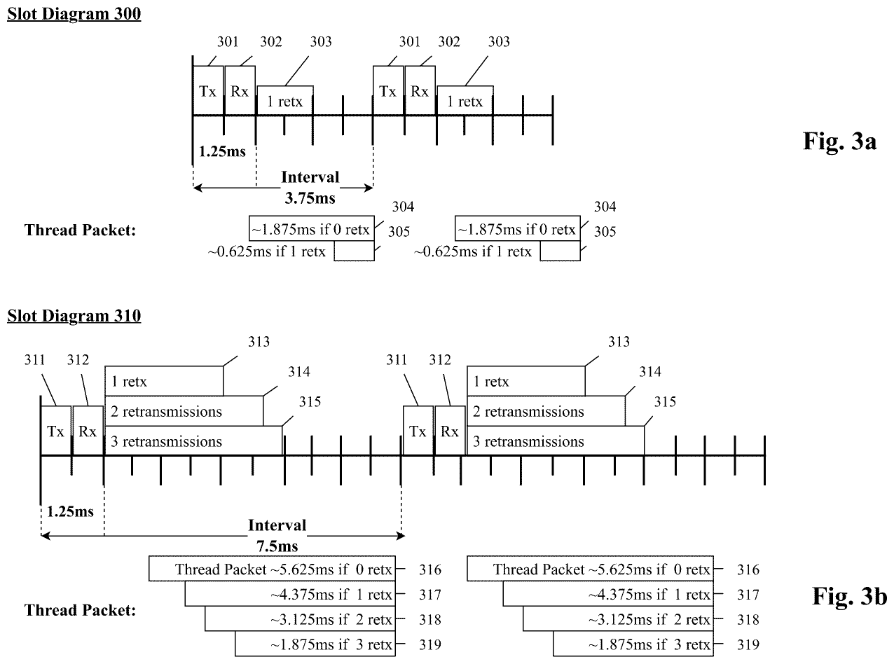

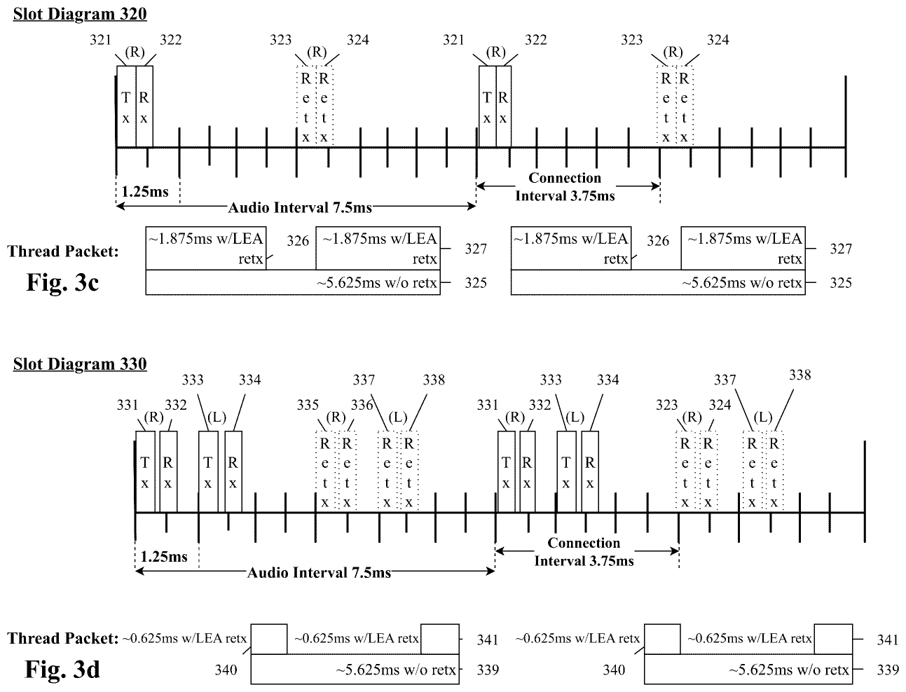

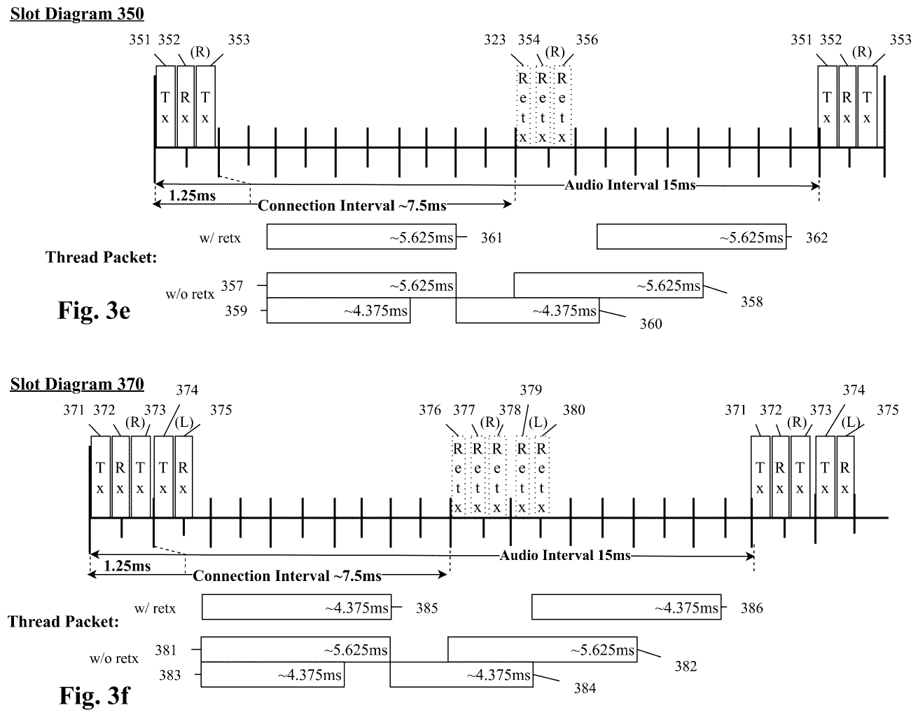

In some embodiments, based on the periodic nature of the time domain resources available on the second link (e.g., the lack of a continuous time span over which a Thread packet of potentially large size can be transmitted), a packet that cannot fit into the available contiguous time domain resources can be fragmented for transmission on the second link. As shown below in FIGS. 3a-f, various Bluetooth technologies and configuration parameters (e.g., whether one or more retransmissions is configured) use different time domain resources on the first link and the available time domain resources for the second link will vary accordingly. In some scenarios, the available time domain resources for the second link will be too small to support the minimum packet size for the second link. When the second link is a Thread link, the minimum packet size may be 60 bytes. In some example embodiments, when the minimum packet size cannot be transmitted in the available time domain resources, no transmissions or receptions may be made on the second link until the loading on the first link changes. In other example embodiments, the module for the second link may request a change in the configuration parameters on the first link so that more space is available, e.g., at least enough space to support the minimum packet size. It is noted that, for different types of radio protocols other than Thread, the minimum packet size may be a different size.

If the contiguous time domain resources available on the second link are sufficient to support at least the minimum packet size, then data packets can be fragmented for transmission on the second link. The module enabling the second link may determine, from the traffic load information for the first link, a fragment size that fits between the transmissions/receptions on the first link. In one example embodiment, if the UE transmits a fragmented packet across non-contiguous time domain resources on the second link, the second short-range device receiving the fragmented packet can determine the traffic pattern of the UE and adjust its operations in dependence thereon. In one example, the second short-range device can transmit to the UE in the resources available to the UE on the second link.

In the example embodiments described above, the first module facilitating the first link may not consider the requirements or interests of the second module facilitating the second link. In other embodiments, the first module may receive traffic load-related information from the second module and adjust its operations based on this information. In one example, if the first link is configured with one or more retransmissions, the first module may, in response to the load information for the second link, determine that fewer or no retransmissions are acceptable and adjust its link parameters so that fewer or no retransmissions are used and the second module has more resources for communications on the second link. However, in many Bluetooth applications no dynamic switching of link parameters is allowed, in consideration of the time sensitivity of many Bluetooth communications.

In another example embodiment, the priority between the first and second links may change based on a state of operations on the second link. In one example, the operations on a Thread link may comprise a first state in which a remote device is woken up by the UE, a second state in which the UE and the remote device connect, and a third state in which a command is transmitted by the UE for execution by the remote device. The command may be, for example, to unlock a door. In this example, the first state (wakeup) and third state (command execution) may take more time than the second state (connect). In this case, the first and third states for the second link may not be prioritized over the first link but, for the second state that can be performed quickly, the second link may be prioritized over the first link without substantially affecting the performance over the first link.

In the following FIGS. 3a-f, example traffic patterns for different types of links are described. Based on the periodic traffic pattern for a particular prioritized link (e.g., Bluetooth link), a certain duration of time (contiguous or non-contiguous) is available per interval for transmissions over the non-prioritized link (e.g., Thread link). It is noted that, for a Thread packet, the minimum packet length for transmitting a minimum Thread packet size (60 bytes) is 3.556 ms. Thus, in scenarios where the traffic pattern on the first link does not provide at least 3.556 ms of contiguous time domain resources for the second link, no transmissions or receptions can be made on the second link until the load on the first link changes.

FIG. 3a shows a slot diagram 300 including example patterns for traffic over a first type of radio link for a first short range protocol and available resources for traffic over a simultaneously configured radio link for a second short range protocol according to a first example. In the present example, the first type of radio link is a synchronous connection-oriented (SCO) Bluetooth link. The slot length is 1.25 ms and the interval is 3.75 ms (3 slots). For this type of radio link, 0 or 1 retransmission attempts are allowed. For a given interval, a first packet 301 can be transmitted and a second packet 302 can be received successively in the first slot. If retransmissions are configured, the one retransmission 303 is performed in the second slot.

Accordingly, if retransmissions are not configured, a duration 304 of ˜1.875 ms (1.5 slots) can be used for transmitting a packet over the simultaneously configured radio link. If one retransmission is configured, a duration 305 of ˜0.625 ms (0.5 slot) can be used for transmitting a packet over the simultaneously configured radio link.

FIG. 3b shows a slot diagram 310 including example patterns for traffic over a second type of radio link for a first short range protocol and available resources for traffic over a simultaneously configured radio link for a second short range protocol according to a second example. In the present example, the second type of radio link is an enhanced SCO (eSCO) Bluetooth link. The slot length is 1.25 ms and the interval is 7.5 ms (6 slots). For this type of radio link, 0, 1, 2 or 3 retransmission attempts are allowed. For a given interval, a first packet 311 can be transmitted and a second packet 312 can be received successively in the first slot. If one retransmission is configured, the retransmission 313 is performed in the second slot. If two retransmissions are configured, the second retransmission 314 is performed in the third slot. If three retransmissions are configured, the third retransmission 316 is performed in the fourth slot.

Accordingly, if retransmissions are not configured, a duration 316 of ˜5.625 ms (4.5 slots) can be used for transmitting a packet over the simultaneously configured radio link. If one retransmission is configured, a duration 317 of ˜4.375 ms (3.5 slots) can be used for transmitting a packet over the simultaneously configured radio link. If two retransmissions are configured, a duration 318 of ˜3.125 ms (2.5 slots) can be used for transmitting a packet over the simultaneously configured radio link. If three retransmissions are configured, a duration 319 of ˜1.875 ms (1.5 slots) can be used for transmitting a packet over the simultaneously configured radio link.

FIG. 3c shows a slot diagram 320 including example patterns for traffic over a third type of radio link for a first short range protocol and available resources for traffic over a simultaneously configured radio link for a second short range protocol according to a third example. In the present example, the third type of radio link is a first type of Bluetooth audio link for a single hearing aid. The slot length is 1.25 ms, the connection interval is 3.75 ms (3 slots) and the audio interval is 7.5 ms (6 slots). For this type of radio link, 0 or 1 retransmission attempts are allowed. For a given audio interval, a first packet 321 can be transmitted and a second packet 322 can be received successively in the first slot. If retransmissions are configured, a first retransmission packet 323 for transmission and a second retransmission packet 324 for reception are transmitted/received successively in the fourth slot.

Accordingly, if retransmissions are not configured, a duration 325 of ˜5.625 ms (4.5 slots) can be used for transmitting a packet over the simultaneously configured radio link. If one retransmission is configured, a first duration 326 of ˜1.875 ms (1.5 slot) and a second duration 327 of 1.875 ms (1.5 slot) can be used for transmitting a packet over the simultaneously configured radio link.

FIG. 3d shows a slot diagram 330 including example patterns for traffic over a fourth type of radio link for a first short range protocol and available resources for traffic over a simultaneously configured radio link for a second short range protocol according to a fourth example. In the present example, the fourth type of radio link is the first type of Bluetooth audio link for two hearing aids. The slot length is 1.25 ms, the connection interval is 3.75 ms (3 slots) and the audio interval is 7.5 ms (6 slots). For this type of radio link, 0 or 1 retransmission attempts are allowed. For a given audio interval, a first packet 331 can be transmitted and a second packet 332 can be received successively in the first slot for a first hearing aid, e.g., the right hearing aid. A third packet 333 can be transmitted and a fourth packet 334 can be received successively in the second slot for a second hearing aid, e.g., the left hearing aid. If retransmissions are configured, a first retransmission packet 335 for transmission and a second retransmission packet 336 for reception are transmitted/received successively in the fourth slot for the first hearing aid and a third retransmission packet 337 and a fourth retransmission packet 338 for reception are transmitted/received successively in the fifth slot.

Accordingly, if retransmissions are not configured, a duration 339 of ˜4.375 ms (3.5 slots) can be used for transmitting a packet over the simultaneously configured radio link. If one retransmission is configured, a first duration 340 of ˜0.625 ms (0.5 slot) and a second duration 341 of 0.625 ms (0.5 slot) can be used for transmitting a packet over the simultaneously configured radio link.

FIG. 3e shows a slot diagram 350 including example patterns for traffic over a fifth type of radio link for a first short range protocol and available resources for traffic over a simultaneously configured radio link for a second short range protocol according to a fifth example. In the present example, the fifth type of radio link is a second type of Bluetooth audio link for a single hearing aid. The slot length is 1.25 ms, the connection interval is 7.5 ms (6 slots) and the audio interval is 15 ms (12 slots). For this type of radio link, 0 or 1 retransmission attempts are allowed. For a given audio interval, a first packet 351 can be transmitted, a second packet 352 can be received, and a third packet 353 can be transmitted successively in the first slot. If retransmissions are configured, a first retransmission packet 354 for transmission, a second retransmission packet 355 for reception, and a third retransmission packet 356 for transmission are transmitted/received successively in the seventh slot.

Accordingly, if retransmissions are not configured, a first pattern including a first duration 357 of ˜5.625 ms (4.5 slots) and/or a second duration 358 of ˜5.625 ms (4.5 slots) can be used for transmitting a packet over the simultaneously configured radio link. A second pattern including a first duration 359 of ˜4.375 ms (3.5 slots) and/or a second duration 360 of ˜4.375 ms (3.5 slots) can be used for transmitting a packet over the simultaneously configured radio link. If one retransmission is configured, a first duration 361 of ˜5.625 ms (4.5 slots) and/or a second duration 362 of ˜5.625 ms (4.5 slots) can be used for transmitting a packet over the simultaneously configured radio link.

FIG. 3f shows a slot diagram 370 including example patterns for traffic over a sixth type of radio link for a first short range protocol and available resources for traffic over a simultaneously configured radio link for a second short range protocol according to a sixth example. In the present example, the sixth type of radio link is the second type of Bluetooth audio link for two hearing aids. The slot length is 1.25 ms, the connection interval is 7.5 ms (6 slots) and the audio interval is 15 ms (12 slots). For this type of radio link, 0 or 1 retransmission attempts are allowed. For a given audio interval, a first packet 371 can be transmitted, a second packet 372 can be received, and a third packet 373 can be transmitted successively in the first slot for a first hearing aid, e.g., the right hearing aid. A fourth packet 374 can be transmitted and a second packet 375 can be received successively in the second slot for a second hearing aid, e.g., the left hearing aid. If retransmissions are configured, a first retransmission packet 376 for transmission, a second retransmission packet 377 for reception, and a third retransmission packet 378 for transmission are transmitted/received successively in the seventh slot for the first hearing aid and a fourth retransmission packet 379 for transmission and a fifth retransmission packet 380 for reception are transmitted/received successively in the eighth slot.

Accordingly, if retransmissions are not configured, a first pattern including a first duration 381 of ˜5.625 ms (4.5 slots) and/or a second duration 382 of ˜5.625 ms (4.5 slots) can be used for transmitting a packet over the simultaneously configured radio link. A second pattern including a first duration 383 of ˜4.375 ms (3.5 slots) and/or a second duration 384 of ˜4.375 ms (3.5 slots) can be used for transmitting a packet over the simultaneously configured radio link. If one retransmission is configured, a first duration 385 of ˜4.375 ms (3.5 slots) and/or a second duration 386 of ˜4.375 ms (3.5 slots) can be used for transmitting a packet over the simultaneously configured radio link.

In view of the above, it is apparent that different time durations are available for the transmission of packets over the second radio link depending on the traffic load over the first radio link. In view of the above, the UE can transmit/receive packets over the second radio link depending on the traffic pattern for the first link.

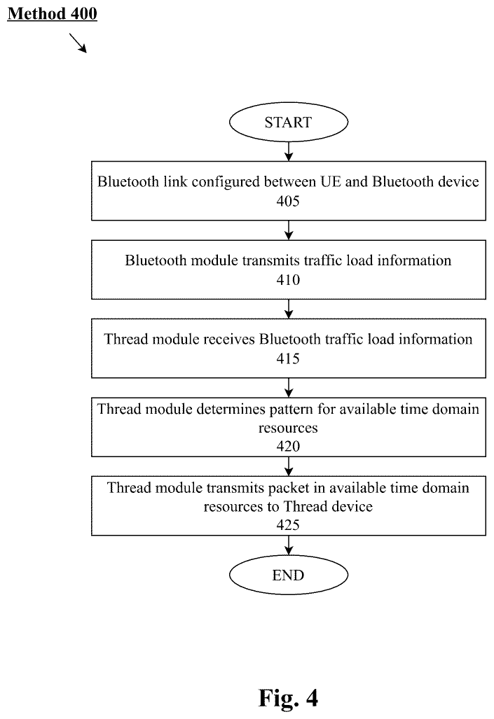

FIG. 4 shows a method 400 for coexistence between a first short-range communications protocol and a second short-range communications protocol when radio links for these protocols are simultaneously configured and these links share an antenna according to various example embodiments. In this example, the first short-range communications protocol is Bluetooth and the second short range communications protocol is Thread. The method 400 is described with regard to a user equipment (UE) configured simultaneously with a Bluetooth link and a Thread link that share an antenna for Tx/Rx traffic.

In 405, a Bluetooth link is configured between the UE and a Bluetooth device. The parameters for the link are established at connection setup. Generally, for many Bluetooth technologies (particularly, audio technologies), it is important to maintain a high quality connection with no audio gaps and/or losing the audio connection. To avoid these issues, there is typically no dynamic switching of Bluetooth link parameters.

In 410, a Bluetooth module transmits traffic load information directly to a Thread module or indirectly via another logical entity that may relay this information (or parameters derived therefrom) to the Thread module. The traffic load information may indicate which slots are in use per interval on the Bluetooth link. The values of the traffic load information may depend on the type of Bluetooth link, e.g., SCO, eSCO, audio link, and whether one or more retransmissions are configured.

In 415, the Thread module receives the Bluetooth traffic load information. A Thread link may have been previously established at the time the Bluetooth link is established in 410, or the Thread link may be established after the Bluetooth link.

In 420, the Thread module determines a pattern for available time domain resources per Bluetooth interval based on the Bluetooth traffic load information.

In 425, based on the length of contiguous available time domain resources, the Thread module determines a fragment size for transmitting a Thread packet. If the length of contiguous available time domain resources is less than those needed to transmit a minimum packet size, the Thread module cannot transmit on the second link. If the length of contiguous available time domain resources is greater than or equal to those needed to transmit a minimum packet size, the Thread module determines a fragment size that fits within these resources. As shown in FIGS. 3a-f above, the fragment can have a length of, e.g., 3.556 ms, 4.375 ms or 5.625 ms.

In 430, the Thread module transmits a fragmented packet in the available time domain resources to a Thread device.

In some embodiments, if the UE transmits a fragmented packet across non-contiguous time domain resources on the second link, the second short-range device receiving the fragmented packet can determine the traffic pattern of the UE and adjust its operations in dependence thereon.

In some embodiments, certain types of operations to be performed by the Thread module (e.g., Thread state) can have priority over Bluetooth. In this scenario, the Thread module transmits/receives without regard to the first link and the Bluetooth module may wait until the Thread state changes and Bluetooth is prioritized.

In some embodiments, if the Bluetooth loading changes, then updated Bluetooth load information can be provided to the Thread module. Based on the updated information, the Thread module can adapt its operations, e.g., according to steps 420-430 above.

In some embodiments, if the Thread state changes, the priority between the Bluetooth link and the Thread link may change. In this case, the Thread module can adapt its operations (if, for example, the updated Thread state has a different priority than the previous Thread state relative to Bluetooth).

### EXAMPLES

In a first example, a method, comprising establishing a first radio link for short range communications using a first protocol and a second radio link for short range communications using a second protocol, wherein the first and second radio links share an antenna, processing traffic load information for the first radio link, the information being dependent on configuration parameters for the first radio link, determining, based on the information, time domain resources available for second data traffic on the second radio link, based on the time domain resources available for the second data traffic on the second radio link, determining a fragmentation size for packets sent on the second radio link and generating transmissions to exchange the second data traffic in the time domain resources available for the second data traffic on the second radio link in fragmented packets according to the determined fragmentation size.

In a second example, the method of the first example, wherein a first module is related to the first radio link and a second module is related to the second radio link, and wherein the information related to a transmission and reception pattern for first data traffic on the first radio link is received by the second module from the first module.

In a third example, the method of the second example, wherein the second module receives updated traffic load information for the first radio link and based on the updated traffic load information, adapts the fragmentation size for packets sent on the second radio link.

In a fourth example, the method of the second example, wherein, when the time domain resources available for the second data traffic on the second radio link does not comprise contiguous time domain resources sufficient to support a minimum packet size on the second radio link, the second data traffic is not exchanged until updated traffic load information for the first radio link is received and the updated traffic load information indicates updated time domain resources available for the second data traffic on the second radio link comprise contiguous time domain resources sufficient to support a minimum packet size on the second radio link.

In a fifth example, the method of the second example, wherein the fragmentation size depends on the configuration parameters for the first radio link including a type of the first radio link.

In a sixth example, the method of the fifth example, wherein the first radio link is a Bluetooth link and the type of the Bluetooth link comprises one of a synchronous connection-oriented (SCO) Bluetooth link, an enhanced synchronous connection-oriented (eSCO) Bluetooth link, a first audio Bluetooth link for one hearing aid, or a second audio Bluetooth link for two hearing aids.

In a seventh example, the method of the sixth example, wherein the transmission and reception pattern for the first data traffic is dependent on a number of retransmissions configured for the Bluetooth link, wherein the number of retransmissions configured for the SCO Bluetooth link is 0 or 1, the number of retransmissions configured for the eSCO Bluetooth link is 0, 1, 2 or 3, the number of retransmissions configured for the first audio Bluetooth link is 0 or 1, and the number of retransmissions configured for the second audio Bluetooth link is 0 or 1.

In an eighth example, the method of the seventh example, wherein the second radio link is a Thread link.

In a ninth example, the method of the seventh example, wherein the Bluetooth link has a higher priority than the Thread link.

In a tenth example, the method of the seventh example, wherein the Bluetooth link has a higher priority than the Thread link when Thread operations comprise a first state and the Thread link has a higher priority than the Bluetooth link when Thread operations comprise a second state.

In an eleventh example, the method of the tenth example, wherein the first state comprises wakeup operations or command execution operations for a Thread device and the second state comprises connection operations for the Thread device.

In a twelfth example, the method of the tenth example, wherein, when the Thread state changes, the second module adapts a priority for the second link relative to the first link.

In a thirteenth example, a processor configured to perform any of the methods of the first through twelfth examples.

In a fourteenth example, a user equipment (UE) configured to perform any of the methods of the first through twelfth examples.

In a fifteenth example, a wireless communication device configured to perform any of the methods of the first through twelfth examples.

In a sixteenth example, a method, comprising establishing a radio link for short range communications using a wireless protocol, processing data traffic on the radio link from a source device, the data traffic transmitted by the source device in a transmission pattern with a fragmentation size, detecting the fragmentation size and the transmission pattern and generating, for transmission on the radio link to the source device, transmissions in accordance with the detected fragmentation size and the transmission pattern.

In a seventeenth example, the method of the sixteenth example, wherein the wireless protocol is Thread.

In an eighteenth example, a processor configured to perform any of the methods of the sixteenth through seventeenth examples.

In a nineteenth example, a user equipment (UE) configured to perform any of the methods of the sixteenth through seventeenth examples.

In a twentieth example, a wireless communication device configured to perform any of the methods of the sixteenth through seventeenth examples.

Those skilled in the art will understand that the above-described example embodiments may be implemented in any suitable software or hardware configuration or combination thereof. An example hardware platform for implementing the example embodiments may include, for example, an Intel x86 based platform with compatible operating system, a Windows OS, a Mac platform and MAC OS, a mobile device having an operating system such as iOS, Android, etc. The example embodiments described above may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

What is claimed:

1. An apparatus comprising processing circuitry configured to:
establish a first radio link for short range communications using a first protocol and a second radio link for short range communications using a second protocol, wherein the first and second radio links share an antenna;
process traffic load information for the first radio link, the information being dependent on configuration parameters for the first radio link;
determine, based on the information, time domain resources available for second data traffic on the second radio link;
based on the time domain resources available for the second data traffic on the second radio link, determine a fragmentation size for packets sent on the second radio link; and
generate transmissions to exchange the second data traffic in the time domain resources available for the second data traffic on the second radio link in fragmented packets according to the determined fragmentation size.

2. The apparatus of claim 1, wherein the processing circuitry executes a first module related to the first radio link and a second module related to the second radio link, and wherein the information related to a transmission and reception pattern for first data traffic on the first radio link is received by the second module from the first module.

3. The apparatus of claim 2, wherein the second module receives updated traffic load information for the first radio link and based on the updated traffic load information, adapts the fragmentation size for packets sent on the second radio link.

4. The apparatus of claim 2, wherein, when the time domain resources available for the second data traffic on the second radio link does not comprise contiguous time domain resources sufficient to support a minimum packet size on the second radio link, the second data traffic is not exchanged until updated traffic load information for the first radio link is received and the updated traffic load information indicates updated time domain resources available for the second data traffic on the second radio link comprise contiguous time domain resources sufficient to support a minimum packet size on the second radio link.

5. The apparatus of claim 2, wherein the fragmentation size depends on the configuration parameters for the first radio link including a type of the first radio link.

6. The apparatus of claim 5, wherein the first radio link is a Bluetooth link and the type of the Bluetooth link comprises one of a synchronous connection-oriented (SCO) Bluetooth link, an enhanced synchronous connection-oriented (eSCO) Bluetooth link, a first audio Bluetooth link for one hearing aid, or a second audio Bluetooth link for two hearing aids.

7. The apparatus of claim 6, wherein the transmission and reception pattern for the first data traffic is dependent on a number of retransmissions configured for the Bluetooth link, wherein the number of retransmissions configured for the SCO Bluetooth link is 0 or 1, the number of retransmissions configured for the eSCO Bluetooth link is 0, 1, 2 or 3, the number of retransmissions configured for the first audio Bluetooth link is 0 or 1, and the number of retransmissions configured for the second audio Bluetooth link is 0 or 1.

8. The apparatus of claim 7, wherein the second radio link is a Thread link.

9. The apparatus of claim 8, wherein the Bluetooth link has a higher priority than the Thread link.

10. The apparatus of claim 8, wherein the Bluetooth link has a higher priority than the Thread link when Thread operations comprise a first state and the Thread link has a higher priority than the Bluetooth link when Thread operations comprise a second state.

11. The apparatus of claim 10, wherein the first state comprises wakeup operations or command execution operations for a Thread device and the second state comprises connection operations for the Thread device.

12. The apparatus of claim 10, wherein, when the Thread state changes, the second module adapts a priority for the second link relative to the first link.

13. An apparatus comprising processing circuitry configured to:
establish a radio link for short range communications using a wireless protocol;
process data traffic on the radio link from a source device, the data traffic transmitted by the source device in a transmission pattern with a fragmentation size;
detect the fragmentation size and the transmission pattern; and
generate, for transmission on the radio link to the source device, transmissions in accordance with the detected fragmentation size and the transmission pattern.

14. The apparatus of claim 13, wherein the wireless protocol is Thread.

15. A method, comprising:
establishing a first radio link for short range communications using a first protocol and a second radio link for short range communications using a second protocol, wherein the first and second radio links share an antenna;
processing traffic load information for the first radio link, the information being dependent on configuration parameters for the first radio link;
determining, based on the information, time domain resources available for second data traffic on the second radio link;
based on the time domain resources available for the second data traffic on the second radio link, determining a fragmentation size for packets sent on the second radio link; and
generating transmissions to exchange the second data traffic in the time domain resources available for the second data traffic on the second radio link in fragmented packets according to the determined fragmentation size.

16. The method of claim 15, wherein a first module is related to the first radio link and a second module is related to the second radio link, and wherein the information related to a transmission and reception pattern for first data traffic on the first radio link is received by the second module from the first module.

17. The method of claim 16, wherein the second module receives updated traffic load information for the first radio link and based on the updated traffic load information, adapts the fragmentation size for packets sent on the second radio link.

18. The method of claim 16, wherein, when the time domain resources available for the second data traffic on the second radio link does not comprise contiguous time domain resources sufficient to support a minimum packet size on the second radio link, the second data traffic is not exchanged until updated traffic load information for the first radio link is received and the updated traffic load information indicates updated time domain resources available for the second data traffic on the second radio link comprise contiguous time domain resources sufficient to support a minimum packet size on the second radio link.

19. The method of claim 16, wherein the fragmentation size depends on the configuration parameters for the first radio link including a type of the first radio link.

20. The method of claim 19, wherein the first radio link is a Bluetooth link and the type of the Bluetooth link comprises one of a synchronous connection-oriented (SCO) Bluetooth link, an enhanced synchronous connection-oriented (eSCO) Bluetooth link, a first audio Bluetooth link for one hearing aid, or a second audio Bluetooth link for two hearing aids.
